(19) United States
(12) Patent Application Publication
(10) Pub. No.: US 2010/0016896 A1
(43) Pub. Date: Jan. 21, 2010

(54) Infant teething device

(76) Inventor: Stacy Rosenthal, Cheshire, CT (US)

Correspondence Address: THE LAW OFFICES OF STEVEN MCHUGH, LLC, 46 WASHINGTON STREET, MIDDLETOWN, CT, 06457, US

(21) Appl. No.: 12/218,844

(22) Filed: Jul. 18, 2008

(51) Int. Cl. A61J 17/02

(52) U.S. Cl. 606/235

(57) ABSTRACT

An infant teething device is provided and includes a plurality of teething elements, wherein each of the plurality of teething elements is constructed via a cylindrical tube-like structure to form a continuous ring-like structure which defines a center cavity, wherein the plurality of teething elements are associated with each other such that the cylindrical tube-like structure of one of the plurality of teething elements pass through the center cavity of an adjacent teething element of the plurality of teething elements, wherein the center cavities of each of the plurality of teething elements include a diameter of sufficient size to snugly fit over a human hand and loosely associate with a wrist of a human arm.

### FIELD OF THE INVENTION

This invention relates generally to an infant teething device and more particularly to an easily and conveniently tetherable infant teething device which doubles as esthetically pleasing jewelry.

### BACKGROUND OF THE INVENTION

Teething devices (such as teething rings) are well known and are used by babies to help alleviate the pain and discomfort associated with baby teeth cutting through the gums. Such a device is generally intended to be held by the infant in his/her mouth and ‘chewed’ to stimulate the gums and to help the teeth cut through. Typically, the teething device is carried by the caregiver and given to the child as needed.

Unfortunately however, current teething devices have disadvantages associated with them. For example, current teething devices are typically small in size and as such, they become easily lost or dropped on the ground. One approach to address these issues is to tether the teething device to the clothing of the baby using a separate tethering device. However, when tethered to the clothing of the baby the teething device tends to drag on the ground while the baby is crawling around, thus picking up dirt and other pathogens which are then transferred to the baby's mouth. This is undesirable because it is unsanitary and can make the infant ill. Additionally, because tethering devices used to tether the teething device to the infant are usually compression fit devices, which are easily pulled off clothing by the baby, the issue of the device becoming lost is still not solved.

Another approach involves tethering the teething device to either the clothing or the body of the caregiver. When tethered to the body of the caregiver, a separate wrist strap which is connected to the teething device via a tether is typically used. This is undesirable for several reasons. First, this still requires the use of a separate element, i.e. the wrist strap, which can become lost. Second, the wrist straps are not esthetically pleasing. And third, the wrist straps are typically made of poor quality and are connected using Velcro® or snaps which can break or become loose when pulled on by the infant. When connected to the clothing of the caregiver, a pin or a compression device connected to the teething device via a tether is typically used. This is also undesirable for multiple reasons. First, this still requires the use of a separate element, i.e. the pin or compression element. Second, the pin or compression device is typically not esthetically pleasing and when pulled on by the infant can either become loose (compression device) or damage the caregivers clothing. In fact, if the pin device fails and becomes loose without the caregiver noticing, the infant can become severely injured.

### SUMMARY OF THE INVENTION

An infant teething device is provided and includes a plurality of teething elements, said plurality of teething elements including a first teething element, a second teething element and a third teething element, wherein each of the plurality of teething elements is constructed via a cylindrical tube-like structure to form a continuous ring-like structure which defines a center cavity, wherein the first teething element and third teething elements are associated with the second teething element such that the cylindrical tube-like structures of the first teething element and the third teething element pass through the center cavity of the second teething element, wherein the center cavities of the first teething element, the second teething element and the third teething element include a diameter of sufficient size to snugly fit over a human hand and loosely associate with a wrist of a human arm.

An infant teething device is provided and includes a plurality of teething elements, wherein each of the plurality of teething elements is constructed via a cylindrical tube-like structure to form a continuous ring-like structure which defines a center cavity, wherein the plurality of teething elements are associated with each other such that the cylindrical tube-like structure of one of the plurality of teething elements pass through the center cavity of an adjacent teething element of the plurality of teething elements, wherein the center cavities of each of the plurality of teething elements include a diameter of sufficient size to snugly fit over a human hand and loosely associate with a wrist of a human arm.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a front view of a teething device illustrating the teething elements associated with each other in accordance with a first embodiment;

FIG. 2 is a side view of the teething elements of the teething device of FIG. 1 disassociated from each other;

FIG. 3 is a front view of the teething device of FIG. 1;

FIG. 4A is a planar view of the teething device of FIG. 1 associated with the wrist of a caregiver and configured as a bracelet;

FIG. 4B is a planar view of the teething device of FIG. 1 associated with the wrist of a caregiver and configured as a teething device;

FIG. 5 is a front view of a teething device illustrating the teething elements associated with each other and including one type of stimulating element in accordance with a second embodiment; and

FIG. 6 is a front view of a teething device illustrating the teething elements associated with each other and including another type of stimulating element in accordance with a second embodiment.

### DETAILED DESCRIPTION

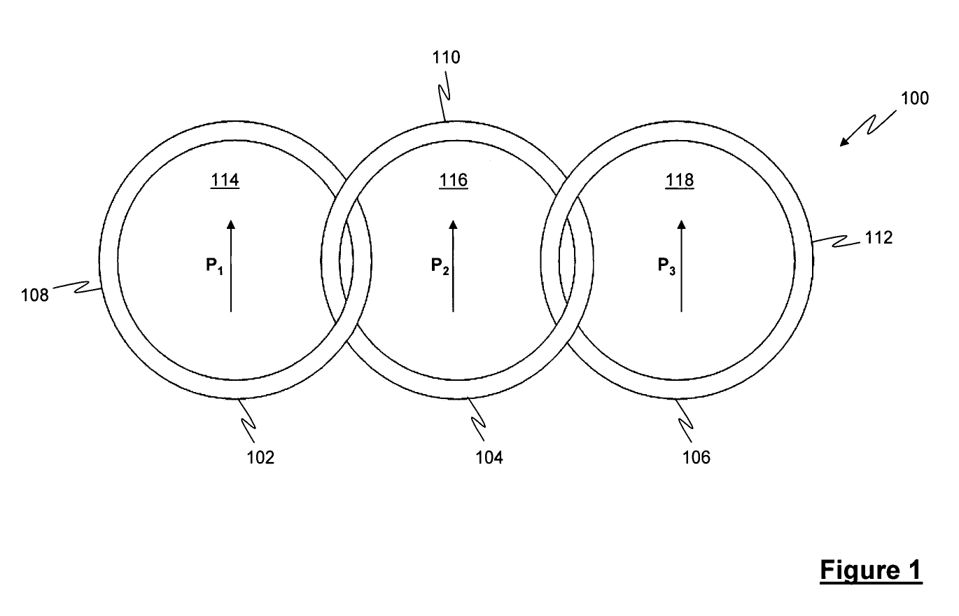

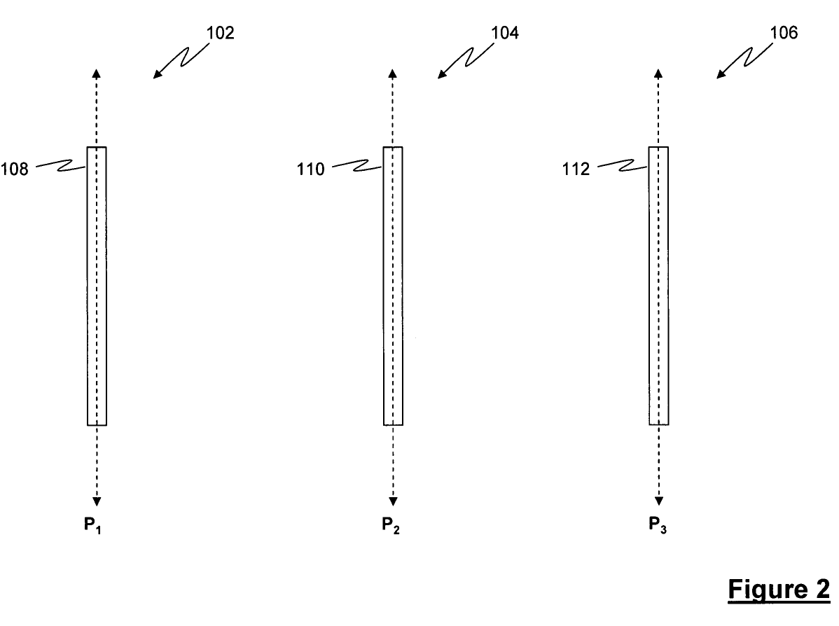

In accordance with the present invention, a first embodiment of a teething device 100 is shown and includes several teething elements 102, 104, 106 securingly associated together in a loop like fashion. As shown in FIG. 1 and FIG. 2 each of the teething elements 102, 104, 106 are constructed of cylindrical ‘tube’ like structures 108, 110, 112, respectively, which may be solid or hollow and which are bent inward toward themselves and which are connected to themselves in a smooth and continuous fashion to form ring-like shapes which define teething element cavities 114, 116, 118 having teething element cavity planes P₁, P₂, P₃, respectively. For illustration purposes, FIG. 2 illustrates a side view of teething elements 102, 104 and 106 separated from each other and showing cavity planes P₁, P₂ and P₃ as intersecting cylindrical tube structures 108, 110 and 112, respectively.

As shown in FIG. 1, the first teething element 102 is associated with the second teething element 104 such that at least a portion of the cylindrical ‘tube’ like structure 108 is disposed within the teething element cavity 114 to intersect the teething element cavity plane P₁. Additionally, the second teething element 104 is associated with the first teething element 102 such that at least a portion of the cylindrical ‘tube’ like structure 110 is disposed within the teething element cavity 116 to intersect the teething element cavity plane P₂. In a similar fashion, the second teething element 104 is associated with the third teething element 106 such that at least a portion of the cylindrical ‘tube’ like structure 110 is disposed within the teething element cavity 118 to intersect the teething element cavity plane P₃. Additionally, the third teething element 106 is associated with the second teething element 104 such that at least a portion of the cylindrical ‘tube’ like structure 112 is disposed within the teething element cavity 116 to intersect the teething element cavity plane P₂.

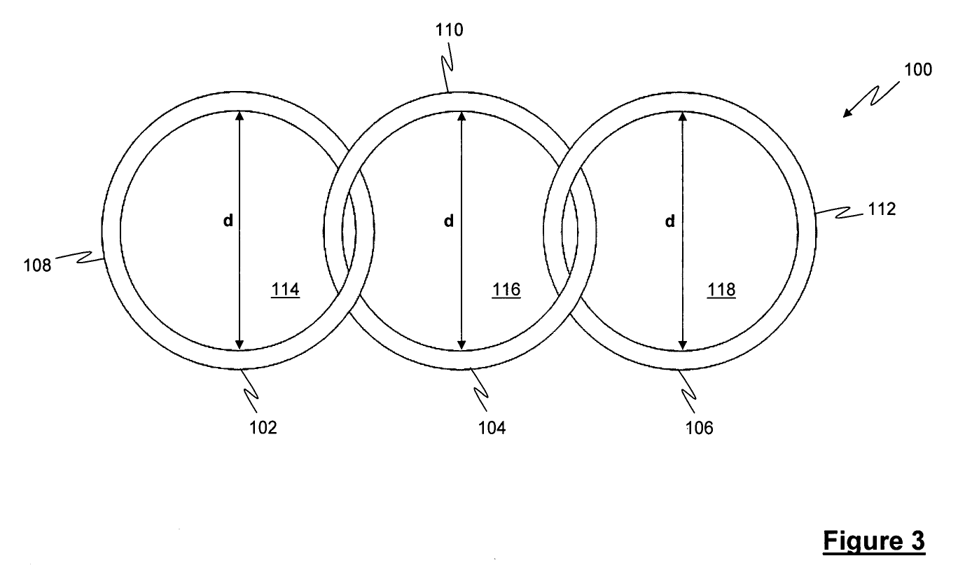

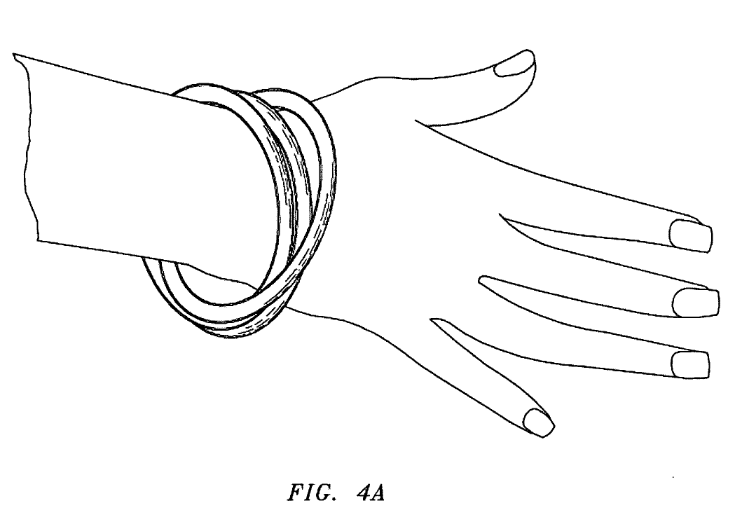

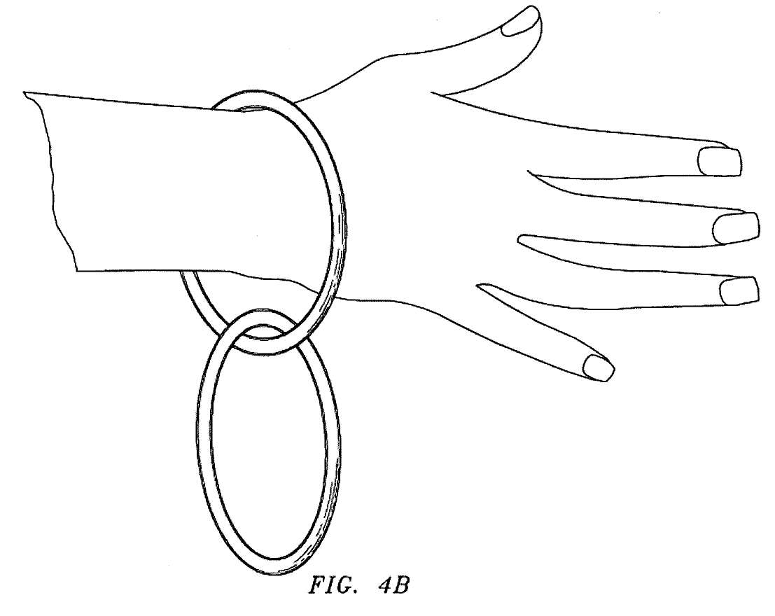

In accordance with the present invention, each of the teething element cavities 114, 116 and 118 include a cavity diameter d that is sized to snugly pass over the hand of a caregiver to be loosely associated with the wrist area of the caregiver, as shown in FIG. 3, FIG. 4A and FIG. 4B. This prevents the teething elements 102, 104, 106 from inadvertently slipping off of the wrist while allowing the teething device 100 to be configured as a bracelet which is esthetically pleasing and as a teething device that is securely and loosely associated with the wrist of the caregiver. One advantage of the present invention is that a caregiver can appear in formal or informal dress while wearing the teething device 100 as jewelry. When the baby is in need of the teething device 100, the caregiver simply slides the first teething element 102 and second teething element 104 off of his/her arm such that only the third teething element 106 remains on his/her arm, thereby tethering the first teething element 102 and the second teething element 104 to the caregiver. The caregiver is not required to search through a bag to locate a teething ring. The baby is then free to grab, play and chew on the teething elements 102, 104, 106 while the caregiver holds the baby. This design is also advantageous because the use of multiple teething elements 102, 104, 106 provides enough length to the teething device 100 to allow the baby to move about in the arms of the caregiver without the caregiver having to assume an uncomfortable position. If the baby drops the teething device 100, the teething elements 102, 104, 106 do not fall to the floor and in fact, remain attached to the caregiver.

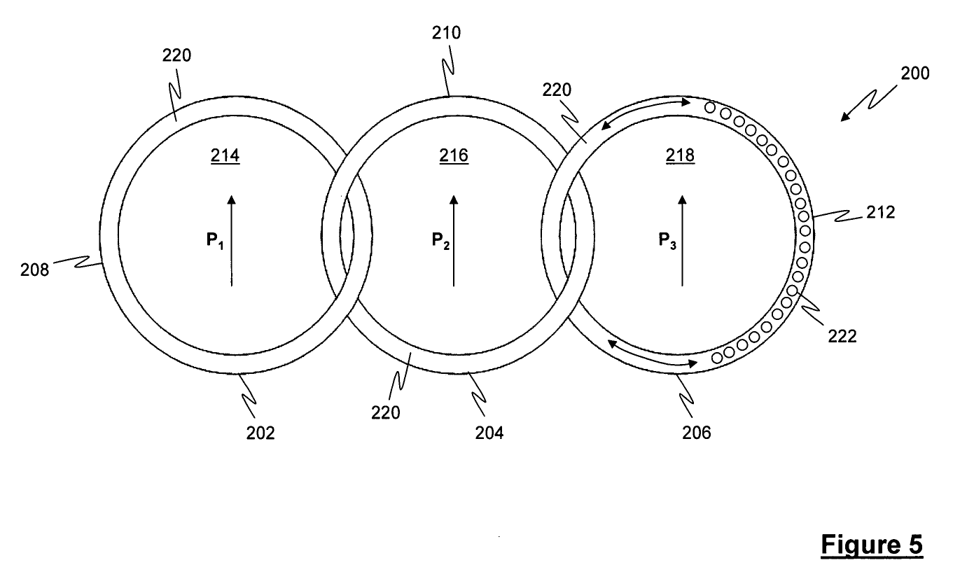

In accordance with a second embodiment of the present invention, a teething device 200 is shown in FIG. 5 and includes a plurality of teething elements 202, 204, 206 securingly associated together in a loop like fashion similar to the teething device 100. In a similar manner to teething device 100, at least one of the teething elements 202, 204 and 206 are constructed of cylindrical ‘tube’ like structures 208, 210, 212, respectively, which are bent inward toward themselves and which are connected to themselves in a smooth and continuous fashion to form ring-like shapes which define teething element cavities 214, 216, 218 having teething element cavity planes P₁, P₂, P₃, respectively.

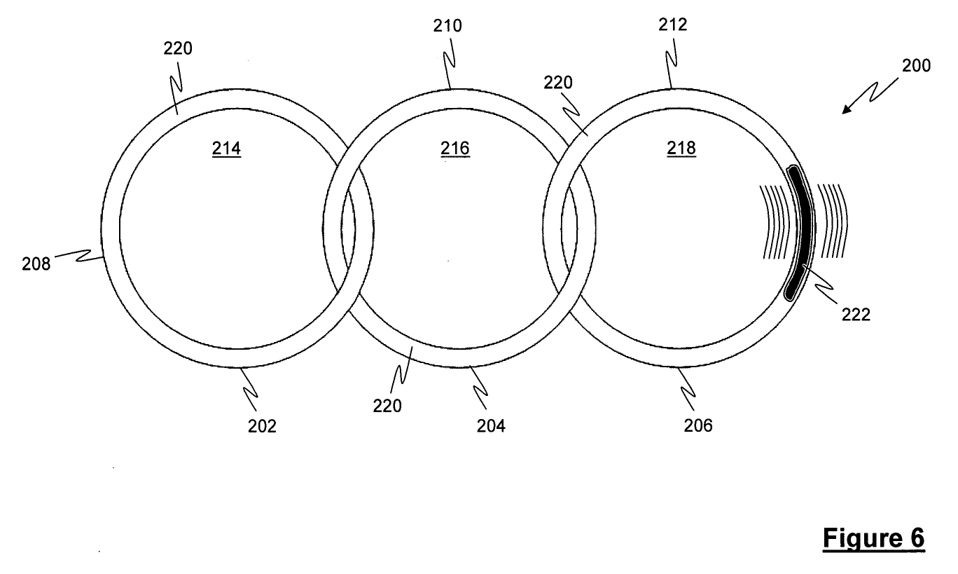

In accordance with a second embodiment, at least one of the cylindrical ‘tube’ like structures 208, 210 and 212 may include a hollow portion 220 having at least one stimulating element 222 disposed within the hollow portion 220 to produce a noise when the cylindrical ‘tube’ like structures 208, 210 and 212 are moved. This advantageously provides aural (acoustic) stimulation to the infant. It is contemplated that all or one of the teething elements 202, 204, 206 may include the stimulating element 222 and that any stimulating element 222 suitable to the desired end purpose may be used, such as ball bearings, metal, stone, glass particulates, and/or an electronic sound element. For example, FIG. 5 shows ball bearings being used as the sound element 222 in third teething element 206 where the ball bearings are allowed to traverse freely about the entire hollow portion 220. It should be appreciated that although the stimulating element 222 is shown herein as being related to sound stimulation, it is contemplated that the stimulating element 222 may be any type of stimulating element suitable to the desired end purpose, such as a vibrating element, a vibrating and sound making element or a stimulating element that causes the teething elements 102, 104, 106, 202, 204 and 206 to vibrate (see FIG. 6), make a sound and/or light up. Additionally, the teething elements 102, 104, 106, 202, 204 and 206 may include a stamped or hammered external portion to give texture to the surface of the element.

Also, in accordance with the present invention, the teething elements 102, 104, 106, 202, 204 and 206 may be constructed from any material or combination of materials suitable to the desired end purpose, such as rubber and/or plastic. However, the teething elements 102, 104, 106, 202, 204 and 206 are preferably constructed from sterling silver for several reasons, including but not limited to its structural properties and/or its perceived anti-bacterial, medical and therapeutic properties. Additionally, it is contemplated that the teething elements 102, 104, 106, 202, 204 and 206 may be constructed of one material (such as plastic) and coated with another material (such as sterling silver). Furthermore, although teething devices 100, 200 are shown as having three teething elements 102, 104, 106, 202, 204 and 206, it is contemplated that the teething devices 100, 200 may have any number of teething elements suitable to the desired end purpose, such as one, two or more teething elements.

Moreover, the ‘tube’ like structures 108, 110, 112, 208, 210, 212 may be constructed of any size tubing and material width suitable to the desired end purpose. For example, the ‘tube’ like structures 108, 110, 112, 208, 210, 212 may be constructed of about 6.5 mm diameter (or width if rectangular and/or triangular shaped) tubing having an about 0.5 mm material wall width. It should be appreciated that the tube diameter could vary in size to be within the range of about 5 mm to 8 mm and the material width could vary by about −0.3 mm and +1.5 mm. Ideally, the ‘tube’ like structure should have a diameter sized to fit comfortably within the mouth of the infant and should have a wall sized such that the infant cannot collapse the tube wall by biting down on the tube. Additionally, although disclosed herein as being constructed from cylindrically shaped ‘tube’ like structures, the teething elements 102, 104, 106, 202, 204 and 206 may be constructed from any shaped structure as desired. For example, the teething elements may be shaped from a rectangular structure or a triangular structure or any combination of the rectangular shaped, triangular shaped and/or cylindrical shaped structure.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention.

What is claimed is:

1. An infant teething device, comprising:
a plurality of teething elements, said plurality of teething elements including a first teething element, a second teething element and a third teething element, wherein each of the plurality of teething elements is constructed via a cylindrical tube-like structure to form a continuous ring-like structure which defines a center cavity, wherein the first teething element and third teething elements are associated with the second teething element such that the cylindrical tube-like structures of the first teething element and the third teething element pass through the center cavity of the second teething element, wherein the center cavities of the first teething element, the second teething element and the third teething element include a diameter of sufficient size to snugly fit over a human hand and loosely associate with a wrist of a human arm.

2. The infant teething device of claim 1, wherein the cylindrical tube-like structure of at least one of the first teething element, the second teething element and the third teething element includes a hollow portion within the cylindrical tube-like structure.

3. The infant teething device of claim 2, wherein the hollow portion includes a stimulating element.

4. The infant teething device of claim 3, wherein the stimulating element includes at least one of a noise making element, a vibrating element and a light emitting element.

5. The infant teething device of claim 1, wherein at least one of the first teething element, the second teething element and the third teething element are constructed from sterling silver.

6. The infant teething device of claim 1, wherein said cylindrical tube-like structure has a diameter of about 6.5 mm and a material thickness of about 0.5 mm.

7. The infant teething device of claim 1, wherein said cylindrical tube-like structure has a diameter within the range of about 5 mm to 8 mm and a material thickness of about 0.5 mm, wherein the material thickness may vary by about −0.3 mm and +1.5 mm.

8. The infant teething device of claim 1, wherein said cylindrical tube-like structure includes a portion that is at least one of a rectangular shape, a triangular shape and any combination thereof.

9. An infant teething device, comprising:
a plurality of teething elements, wherein each of the plurality of teething elements is constructed via a tube-like structure to form a continuous ring-like structure which defines a center cavity, wherein the plurality of teething elements are associated with each other such that the tube-like structure of one of the plurality of teething elements pass through the center cavity of an adjacent teething element of the plurality of teething elements, wherein the center cavities of each of the plurality of teething elements include a diameter of sufficient size to snugly fit over a human hand and loosely associate with a wrist of a human arm.

10. The infant teething device of claim 9, where the plurality of teething elements include a first teething element, a second teething element and a third teething element.

11. The infant teething device of claim 9, wherein the tube-like structure of at least one of the plurality of teething elements includes a hollow portion within the cylindrical tube-like structure.

12. The infant teething device of claim 11, wherein the hollow portion includes a stimulating element.

13. The infant teething device of claim 12, wherein the stimulating element includes at least one of a noise making element, a vibrating element and a light emitting element.

14. The infant teething device of claim 9, wherein at least one of the plurality of teething elements are constructed from sterling silver.

15. The infant teething device of claim 9, wherein said tube-like structure has a diameter of about 6.5 mm and a material thickness of about 0.5 mm.

16. The infant teething device of claim 9, wherein said tube-like structure has a diameter within the range of about 5 mm to 8 mm and a material thickness of about 0.5 mm, wherein the material thickness may vary by about −0.3 mm and +1.5 mm.

17. The infant teething device of claim 9, wherein said tube-like structure is at least one of a rectangular shape, a triangular shape, a cylindrical shape and any combination thereof.
